(19) United States
(12) Patent Application Publication
(10) Pub. No.: US 2011/0276585 A1
(43) Pub. Date: Nov. 10, 2011

(54) SYSTEMS AND METHODS FOR ACCESSING CONTENT USING AN INTERNET CONTENT GUIDE

(75) Inventors: Bill Wagner, San Diego, CA (US); Brian Oberholtzer, San Diego, CA (US); Shaiwal Priyadarshi, San Diego, CA (US)

(73) Assignee: DivX, LLC, San Diego, CA (US)

(21) Appl. No.: 12/985,222

(22) Filed: Jan. 5, 2011

Related U.S. Application Data
(60) Provisional application No. 61/293,180, filed on Jan. 7, 2010.
(60) Provisional application No. 61/335,592, filed on Jan. 7, 2010.

(51) Int. Cl. G06F 17/30; G06F 15/16

(52) U.S. Cl. 707/769; 709/219; 707/E17.014

(57) ABSTRACT

Systems and methods for providing Internet Content Guides (ICG) on playback devices that can be used to access content via the Internet from a plurality of sources using a remote database containing navigation hierarchy definitions for specific device models and/or device instances are described, where content metadata included in the remote database is collected by a remote server from the plurality of sources. One embodiment of the invention includes a metacenter configured to retrieve content metadata from feeds on a plurality of remote servers describing content accessible via the remote servers and to use the content metadata retrieved from the feeds to update a content metadata database, and a plurality of playback devices configured to communicate with the metacenter and access content via the Internet. In addition, the content metadata database defines a plurality of navigation hierarchies for different playback devices, where each navigation hierarchy includes category information and content information, each playback device is configured to obtain a navigation hierarchy appropriate to the playback device from the metacenter, where the navigation hierarchy obtained by the playback device only includes category and content information that the playback device is authorized to access and is capable of playing back, and the playback devices are configured to generate an Internet content guide using the navigation hierarchy obtained from the metacenter.

### CROSS-REFERENCES TO RELATED APPLICATIONS

The present application claims priority to U.S. Provisional Application No. 61/335,592 entitled “Real Time Flash Based User Interface for Media Playback Device”, filed Jan. 7, 2010, and U.S. Provisional Application No. 61/293,180 entitled “Systems and Methods for Accessing Content Using an Internet Content Guide”, filed Jan. 7, 2010. The disclosure of U.S. Provisional Applications Nos. 61/335,592 and 61/293,180 is hereby incorporated by reference in its entirety.

### BACKGROUND

The present invention generally relates to consumer electronics devices and more specifically to consumer electronics devices configured to playback content accessed via the Internet.

An increasing variety of consumer electronics devices, including but not limited to televisions, DVD/Blu-ray players, set-top boxes, and game consoles, possess the capability of connecting to the Internet. An enormous variety of content exists on the Internet, which is accessible from numerous sources. Each source typically publishes content in its own unique way. Personal computers can access content via the Internet, using a web browser application and a variety of plug-ins that enable viewing of the content, which can include but is not limited to audio, video, music, text, and/or still images. Discovery of content is often facilitated by the recommendations of a specific site, recommendations of other users, and/or a search engine. Navigation using a web browser and search engines is reliant upon use of a keyboard and a pointing device such as a mouse or touchpad. Consumer electronics devices typically provide a remote control or game controller as a user input device. Such input devices are unsuited to navigation using a web browser and/or searching via a search engine. Therefore, manufacturers of consumer electronics devices typically develop user interfaces specific to a particular device that enables the device to access content via the Internet from a limited number of sources. Considerable effort is required to integrate each site from which content is accessible via the user interface and that effort is replicated by each manufacturer and for each class of device.

### SUMMARY OF THE INVENTION

Systems and methods in accordance with embodiments of the invention are described for providing Internet Content Guides (ICC) on playback devices that enable access to content from a variety of sources using a remote database containing navigation hierarchy definitions for specific device models and device instances, where content metadata included in the remote database is collected by a remote server. A common client that can be deployed on a variety of consumer electronics devices is also described. The common client is capable of utilizing the consumer electronic devices Internet connections to pull information from the remote database to build a device specific ICG that provides access to the listed content, where each device specific ICG is navigable using a remote control or game controller.

One embodiment of the invention includes a metacenter configured to retrieve content metadata from feeds on a plurality of remote servers describing content accessible via the remote servers and to use the content metadata retrieved from the feeds to update a content metadata database, and a plurality of playback devices configured to communicate with the metacenter and access content via the Internet. In addition, the content metadata database defines a plurality of navigation hierarchies for different playback devices, where each navigation hierarchy includes category information and content information, each playback device is configured to obtain a navigation hierarchy appropriate to the playback device from the metacenter, where the navigation hierarchy obtained by the playback device only includes category and content information that the playback device is authorized to access and is capable of playing back, and the playback devices are configured to generate an Internet content guide using the navigation hierarchy obtained from the metacenter.

In a further embodiment, the a metacenter is configured to retrieve content metadata from a plurality of remote servers describing content accessible via feeds on the remote servers using metadata adapters configured to retrieve specific content metadata from a specific feed format.

In another embodiment, the metacenter further comprises a metasynthesizer that is configured to schedule the retrieval of content metadata from the plurality of remote servers in accordance with a predetermined schedule.

In a still further embodiment, content metadata retrieved from a feed by the metacenter with respect to a specific piece of content accessible via a remote server associated with the feed includes a unique identifier.

In still another embodiment, the metacenter is configured to compare the unique identifiers of the content metadata retrieved from a specific feed to the unique identifiers of content metadata associated with the feed in the content metadata database, and associate content metadata with the feed, when the unique identifier of the content metadata does not match the unique identifier of any of the content metadata associated with the feed in the content metadata database.

In a yet further embodiment, the metacenter is configured to mark content metadata within the content database as deleted when the unique identifier of content metadata associated with the feed in the content metadata database does not match any of the unique identifiers of the content metadata retrieved for the feed.

In yet another embodiment, the metacenter is configured to update the content metadata stored in the metadata database to reflect differences with the retrieved content metadata, when the unique identifier of the retrieved content metadata corresponds to the unique identifier of content metadata for a piece of content associated with the feed.

In a further embodiment again, the unique identifier for content metadata retrieved by the metadata adapter is the same every time the content metadata for the specific piece of content is retrieved from the feed.

In another embodiment again, the content metadata database defines a complete navigation hierarchy comprising all categories and all content metadata within the content metadata database.

In a further additional embodiment, the content metadata database defines scopes within the complete navigation hierarchy, where each scope limits the categories and content metadata to form a custom navigation hierarchy.

In another additional embodiment, scopes are defined for different classes of playback device.

In a still yet further embodiment, the scope is defined by an administrator based upon the content the class of playback devices is capable of playing back.

In still yet another embodiment, scopes are defined for individual playback devices.

In a still further embodiment again, the scope includes content from custom feeds.

In still another embodiment again, the custom feed is a content feed specified by a user.

In a still further additional embodiment, the custom feed is content metadata identified in response to the execution of a saved search query.

In still another additional embodiment, the scope includes content metadata retrieved from at least one restricted site.

In a yet further embodiment again, the content metadata for content that is accessible via a restricted site includes information that directs the playback device to request access to the content from the metacenter, and the metacenter is configured to obtain information from the restricted site enabling the playback device to access content on the restricted site in response to a request from the playback device to access the content.

In yet another embodiment again, the scope includes user defined filters and the metacenter is configured to filter the navigation hierarchy based upon the filters prior to providing a custom navigation hierarchy to a playback device.

In a yet further additional embodiment, the filter is a parental control filter that filters at least one category and associated content from the navigation hierarchy.

In yet another additional embodiment, the filter is a content rating filter that filters category and content metadata based upon assigned content ratings.

In a further additional embodiment again, the filter is a playback capability filter that filters content metadata based upon the playback capabilities of a playback device.

In another additional embodiment again, each playback device utilizes a common client to obtain a navigation hierarchy from the metacenter.

In a still yet further embodiment again, the playback device is configured to request a navigation hierarchy from the metacenter.

In still yet another embodiment again, the playback device is configured to request a navigation hierarchy update from the metacenter.

In a still yet further additional embodiment, the metacenter is configured to search content accessible via an archive site using a search metadata adapter for the site.

In still yet another additional embodiment, the metacenter is configured to search an archive site in response to receipt of a search query from a playback device.

In another further embodiment, the metacenter is configured to search an archive site using a saved search query in response to a predetermined event.

### BRIEF DESCRIPTION OF THE DRAWINGS

FIG. 1 illustrates a system for accessing content via the Internet using Internet Content Guides generated by playback devices using navigation hierarchy information pulled from a remote database in accordance with an embodiment of the invention.

FIG. 2 illustrates the collection of content metadata and the provision of navigation hierarchy information to a playback device in accordance with an embodiment of the invention.

FIG. 3 illustrates a metasynthesizer including a plurality of metadata adapters in accordance with an embodiment of the invention.

FIGS. 4a and 4b illustrate a process for collecting content metadata and updating content metadata stored within a content metadata database in accordance with an embodiment of the invention.

FIG. 5 illustrates database tables that can be used to define navigation hierarchies for a plurality of device models and device instances in accordance with embodiments of the invention.

FIG. 5a illustrates a process for requesting access to subscription and/or premium content from a subscription and/or premium content service using an ICG generated using information pulled from a metacenter in accordance with an embodiment of the invention.

FIG. 6 illustrates a playback device in accordance with an embodiment of the invention.

FIG. 7a illustrates a process for requesting information from a metacenter in accordance with an embodiment of the invention.

FIG. 7b illustrates a process for requesting access to content from a remote server using a common client in accordance with an embodiment of the invention.

### DETAILED DESCRIPTION

Turning now to the drawings, systems and methods for providing Internet Content Guides (ICG) on playback devices that can be used to access content via the Internet from a plurality of sources using a remote database containing navigation hierarchy definitions for specific device models and device instances, where content metadata included in the remote database is collected by a remote server from the plurality of sources, in accordance with embodiments of the invention are illustrated. In many embodiments, an ICG is a hierarchical menu that users can use to navigate to video content accessible via the Internet from a variety of sites using a standard remote control device or game controller. In several embodiments, the ICG generated by each playback device is defined by a navigation hierarchy that includes navigation nodes within the hierarchy, which typically describe categories such as but not limited to genre, site, and fee, and content nodes, which describe individual pieces of content. The navigation hierarchy for a specific playback device is defined within the remote database and the playback device pulls its navigation hierarchy from the remote database. In a number of embodiments, the navigation hierarchy is defined so that the ICG presented by the playback device only includes listings for categories and content that the playback device is both authorized to playback and capable of playing back.

In a number of embodiments, a metacenter is provided in the cloud that builds the remote database using content metadata adapters to scrape content sites. In a number of embodiments, each content site has a separate content metadata adapter specifically configured based upon the manner in which content is added to each content site. In several embodiments, content sites provide a standard feed and a single metadata adapter can be used to obtain metadata concerning content provided via multiple content sites. In addition to storing content metadata, the content metadata database defines navigation hierarchies for different classes of playback device and for specific playback devices. The navigation hierarchy information can be pulled by playback devices to generate ICGs.

In several embodiments, a plurality of playback devices configured to run a common client can access the metacenter and use information from the content metadata database to generate an ICG that is navigable using the device's controller. In many embodiments, the playback devices are consumer electronic devices that include a remote control or game controller as an input device. In several embodiments, the common client configures the playback devices to implement a Flash player. A Flash player is software that runs Small Web Format (SWF) files, which is a file format specified by Adobe Systems Incorporated of San Jose, Calif. for multimedia, vector graphics, and ActionScripts, and is able to decode Flash Video, which is a container file format that can be used to deliver video over the Internet. The Flash player enables manufacturers to generate different user interfaces using the common client.

In several embodiments, the latency of the user interfaces generated by common clients and playback of content is reduced using caching. In many instances, frequently accessed content is locally cached on the playback device by the common client. In several instances, content is pre-cached based upon the state of the user interface. Metacenters, content metadata adapters, the generation of ICGs by specific playback devices, and common clients in accordance with embodiments of the invention are discussed further below.

### System Architecture

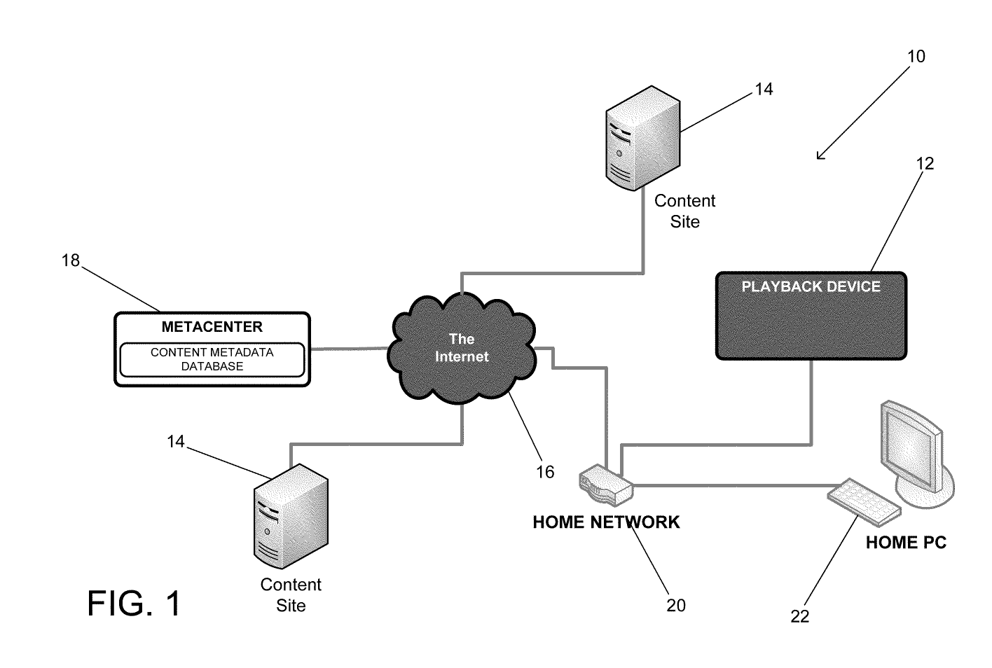

A system for accessing content via the Internet using an ICG generated by a playback device using navigation hierarchy information pulled from a remote database of content metadata in accordance with an embodiment of the invention is illustrated in FIG. 1. The system includes at least one playback device 12, which is configured to playback content that is accessible locally or at content sites 14 via the Internet 16. Each playback device 12 retrieves navigation hierarchy information from a content metadata database that is part of a metacenter 18 via the Internet and uses the retrieved information to generate an ICG that is navigable with the playback device's controller. The metacenter is one or more servers that are configured to manage the collection of content metadata within the content metadata database and the communication of navigation hierarchies to playback devices. In many embodiments, a common client adapted to execute on different classes of playback device is used to generate the user interface. In many embodiments, playback devices include consumer electronics devices such as, but not limited to, televisions, DVD/Blu-ray players, game consoles, mobile devices and set top boxes. Common clients that can be utilized for accessing content via the Internet using an ICG in accordance with an embodiment of the invention are described in U.S. Provisional Application No. 61/335,592 entitled “Real Time Flash Based User Interface for Media Playback Device”, filed Jan. 7, 2010, the disclosure of which is incorporated by reference in its entirety above.

The metacenter 18 constructs the content metadata database by obtaining metadata concerning content available from a number of content sites 14. As is discussed further below, content sites typically use different techniques to provide access to content and/or updates concerning new content added to the content site. In many embodiments, the metacenter 18 uses information concerning the manner in which content sites provide this information to periodically update the content metadata database.

### The Metacenter

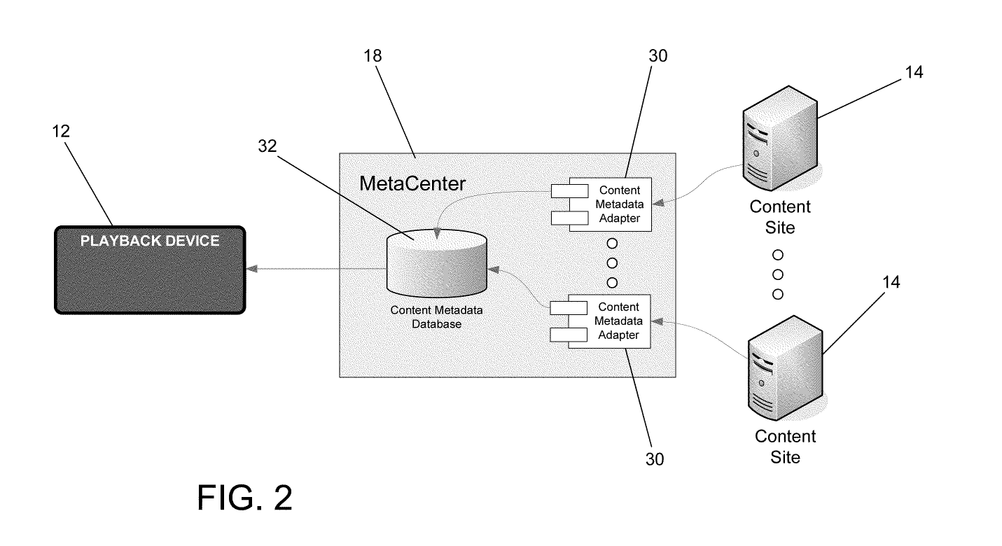

A metacenter in accordance with an embodiment of the invention is illustrated in FIG. 2. The metacenter 18 generates, and maintains a content metadata database, and provides information from the content metadata database to playback devices. In the illustrated embodiment, the metacenter 18 includes a plurality of content metadata adapters 30 and a content metadata database 32, which defines a navigation hierarchy for all content accessible via the Internet via the feeds of which the metacenter 18 is aware. Each content metadata adapter is configured to generate metadata concerning content stored on a particular content site or class of content sites. In several embodiments, the metacenter 18 is configured to generate metadata concerning video, audio, music and photos accessible via a particular content site. The metacenter is not necessarily limited, however, in terms of the content that can be listed in the content metadata database. The retrieved metadata is integrated into the content metadata database to provide an updated navigation hierarchy of content that is accessible via the content sites for which the metacenter possesses metadata adapters.

In many embodiments, the content metadata database 32 includes navigation hierarchies that can be used to construct an ICC on a playback device, which a user can traverse using a playback device's user interface and can use to access content. In a number of embodiments, the metacenter 18 uses information concerning a particular playback device 12, including but not limited to information concerning device playback capabilities, ratings filters, custom feeds, subscription and/or premium services, and/or other account information, to define a navigation hierarchy for the playback device. Navigation scope defines the subset of content referenced in the ICG that can be accessed by a particular device class (e.g., device model or group of device models) or by a specific device. For example, a specific device model can have a scope defined in accordance with the playback capabilities of the device and a specific instance of the device model (i.e., an individual device) can have a modified version of the scope that includes custom feeds (e.g., saved search queries or private content) and/or subscription and/or premium content. The categories and content that are within the scope defined for a specific playback device can be further filtered by the metacenter 18 prior to providing the navigation hierarchy to the playback device. Examples of filters include but are not limited to parental control filters, rating restriction filters, and playback capability filters. Therefore, by defining scopes and applying appropriate filters the metacenter 18 can provide each playback device 12 with a navigation hierarchy that can be used to create a custom ICG that only lists categories and content that the playback device is both authorized to playback and is capable of playing back. In other embodiments, the playback device applies filters to the navigation hierarchy received from the metacenter so that the playback device's ICG only lists content that is capable of playback on the device.

### The Metasynthezier

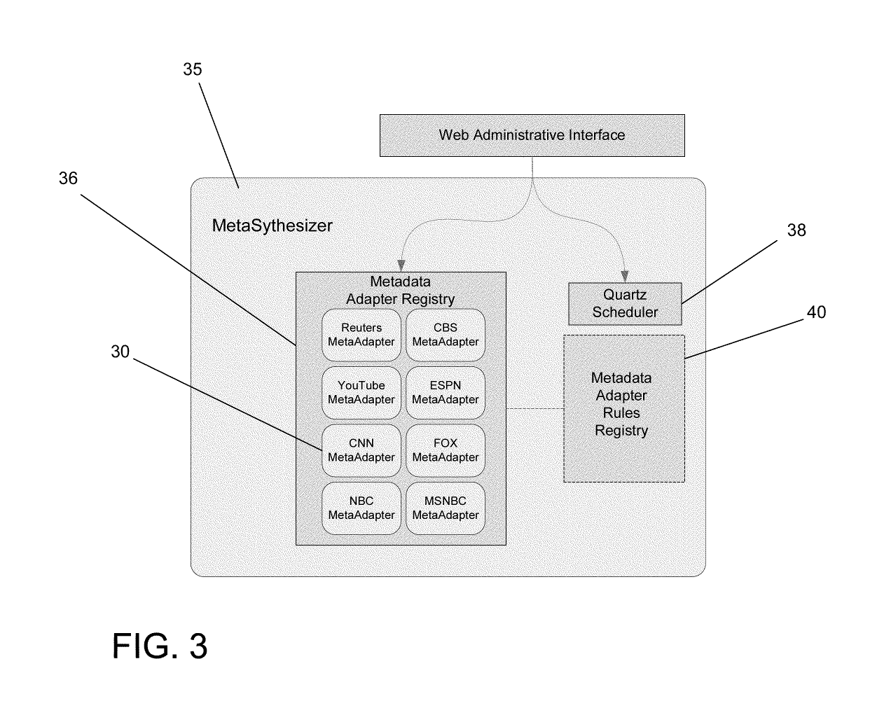

A metacenter can build a content metadata database concerning content accessible via hundreds if not thousands of content sites. The content sites can include but are not limited to video on demand (VOD) movies and other types of pay and non-pay subscription and/or premium content, Internet video (e.g., User Generated Content), Internet audio/music sites and Internet photo sites. Content is continuously added and removed from content sites. In several embodiments, the metacenter 18 uses a scheduler to manage the collection of metadata concerning content accessible via content sites so that information provided to playback devices from the ICG concerning accessible content remains current. A metasynthesizer that performs scheduling and the integration of metadata generated by content metadata adapters into an ICG in accordance with an embodiment of the invention is illustrated in FIG. 3. The metasynthesizer 35 includes a registry 36 of metadata content adapters 30 that are used to obtain metadata from different content sites. In the illustrated embodiment, the metasynthesizer incorporates the open source Quartz Job Scheduler distributed by Terracotta, Inc. of San Francisco, Calif., which enables the scheduling of jobs with a fixed time period. In many embodiments, other techniques are used for real time job scheduling. The metasynthesizer also includes a metadata adapter rules registry 40. The metadata adapter rules registry includes information concerning the metadata adapters that are appropriate for specific URLs and, in many instances, the frequency and/or time of content updates. In several embodiments, the content metadata adapters themselves include a registry of URLs to which the content metadata adapter can be applied and/or the metadata adapter rules registry forms part of the metadata adapter registry. In a number of embodiments, the metasynthesizer also includes push technology enabling content publishers to push information concerning newly published content or new metadata adapter rules to the metasynthesizer.

In many embodiments, the metasynthesizer updates the content metadata database using the metadata obtained from the content metadata adapters. The metasynthesizer can add a new entry to the content metadata database when a piece of content is located for the first time. The metasynthesizer can also mark content entries as deleted, when the piece of content is no longer accessible via a content site, and can mark content entries as updated where the content has changed in some manner, such as a changed URL or thumbnail.

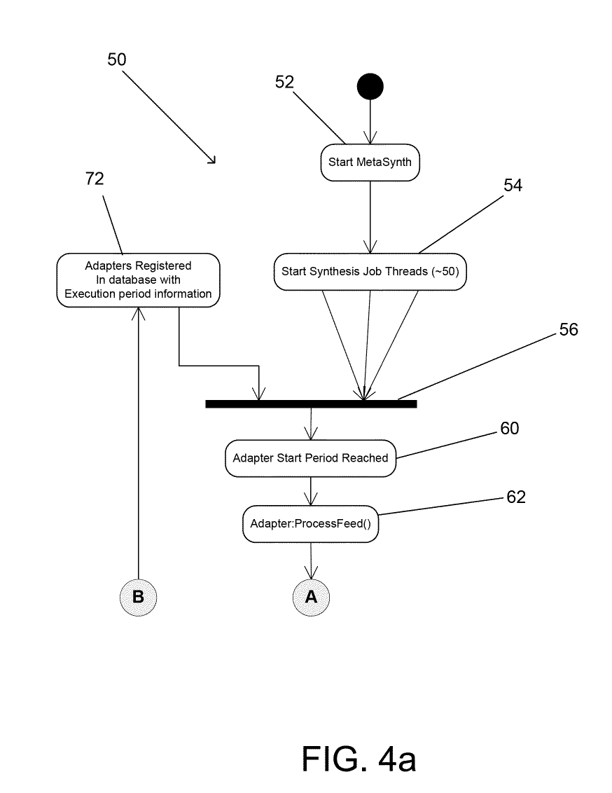

A state diagram illustrating the core logic of a metasynthesizer in accordance with an embodiment of the invention is illustrated in FIGS. 4a and 4b. The process 50 commences with the start (52) of the metasynthesizer process. Under normal operation, the metasynthesizer process is continuously running as a background process. The metasynthesizer spawns (54) multiple synthesis job threads, which queue jobs for the metadata adapters that are enabled in the content metadata database. The solid bar (56) in the state diagram illustrates the job scheduler. When the start period is reached for a specific metadata adapter (60), the metadata adapter is utilized (62) to obtain content metadata for each feed that can be processed via the metadata adapter. In many instances a single site (e.g., a news site) incorporates many feeds such as World News, Staff Favorites, and U.S. news, and the same metadata adapter can be applied to each of the feeds separately. The metadata set returned from the adapter for each feed is separately processed. The metadata adapters assign a unique identifier to each piece of content described in the metadata set returned for a feed. The unique identifier does not change across execution of the adapter for the feed or with modification of the metadata associated with the piece of content. In the illustrated embodiment, the process determines whether specific pieces of content are no longer available from the feed, whether information concerning a piece of content in the feed has been updated, and/or whether new pieces of content have been added to the feed.

In order to determine whether a piece of content has been deleted from the feed, the process retrieves (63) metadata for pieces of content associated with the feed in the content metadata database. The process then determines (64) whether each of the pieces of content retrieved from the content metadata database is listed in the metadata set returned by the metadata adapter for the feed. In the event that a piece of content is not listed, then the piece of content is marked (66) as deleted in the database.

The process then updates the metadata stored in the content metadata database by reviewing each piece of content (66) in the metadata set returned by the metadata adapter for the feed and determining (67) whether the piece of content is already listed in the content metadata database as being available via the feed. In the event the piece of content is not listed, then the metadata for the piece of content is added to the content metadata database and/or associated with the feed. In the event that the piece of content is listed as being available via the feed, a determination (70) is made concerning whether the metadata has changed for the piece of content (e.g., the URL for the content has changed or a thumbnail image associated with the piece of content has changed). In the event that the metadata has changed, the metadata for the piece of content is updated (71) within the content metadata database. When the set of metadata returned by the metadata adapter for the feed has been completely processed, the scheduler selects (72) another metadata adapter based upon schedule information contained within the content metadata database or elsewhere.

In the manner outlined above, the metasynthesizer can continuously build and update a navigation hierarchy for content accessible via the Internet. The metadata contained within the content metadata database can be utilized to generate navigation hierarchies that can be used by playback devices to present an ICG via the playback device's user interface. Although a specific state machine is illustrated in FIGS. 4a and 4b, a variety of processes appropriate to a given application can be utilized to build and update a content metadata database in accordance with an embodiment of the invention.

### Content Metadata Adapters

A metacenter in accordance with embodiments of the invention creates consistent metadata synthesis items for inclusion in a content metadata database from disparately encoded feeds on the Internet using metadata content adapters. The feeds available on the Internet vary in numerous ways. For example, some content may not be provided through standard Atom or RSS feeds. When this is the case, these items may be obtained via APIs, by scraping web pages, or by using other “out-of-band” techniques. Even when a feed is based on the standard RSS or Atom protocols, the field that contains the data often varies and sometimes RSS/Atom extensions are used (Podcast feeds are an example of feeds that use RSS extensions). Content metadata adapters can be created for each site, where each content metadata adapter is an executable application possessing a state machine that incorporates knowledge concerning how to acquire and interpret a feed from a particular content provider. In many instances, a content metadata adapter is associated with an individual Internet site. A content metadata adapter can also, however, be reused by multiple sites when feed information is consistent across the sites (for example, all of the Blip.tv feeds, or all Podcast feeds). In several embodiments, a standard feed format is specified so that a single content adapter can be used to extract metadata content from any site that published information in accordance with the standard feed format.

The metasynthesizer can pass a URL to the metadata adaptor and the metadata adapter typically returns a unique identifier for each piece of content identified by the adapter. The unique identifier assigned by the metadata adapter is invariant across multiple invocations of the metadata adapter. The manner in which the unique identifier is generated depends upon the site. Many sites do not modify the URL for pieces of content. Therefore, the URL can be used as the unique identifier. For sites that modify the URL for pieces of content, the sites themselves typically assign a unique identifier to each piece of content on the site. Therefore, the unique identifier assigned by the site can be utilized to uniquely identify the content. The unique identifier provided by the metadata adapter enables a determination of whether content is being added, updated, or removed when comparing content found by a content adapter to content listings stored in the content metadata database. In a number of embodiments, the same unique identifier is used for a piece of content that appears in multiple feeds from the same site. Utilizing the same unique identifier for each feed can simplify the caching of content, as the piece of content need only be cached once. A content metadata adapter can also return additional information including but not limited to information such as the genres of content offered by a particular site.

In a number of embodiments, the content metadata adapters return metadata as name-value pairs stored within a set of node attributes objects. The expected metadata collected differs based on the type of adapter and adapter method being called. In the majority of instances, the collected metadata includes the URL of the piece of content or another piece of information that can be utilized to access the piece of content. The storage of content metadata in a content metadata database is discussed further below.

### Storing Content Metadata in Content Metadata Database

The metadata adapters enable the storage and updating of metadata concerning pieces of content that are accessible via the Internet within the content metadata database. The content metadata is typically stored within a table within the content metadata database. The types of metadata that can be collected with respect to a piece of content in accordance with an embodiment of the invention can vary depending upon the source of the content. The following XML node tag contains examples of the types of metadata that can be stored in the content metadata database with respect to a specific piece of content:

<node

Title=‘Daley looking forward to Olympics’
ParentID=‘8551’
ID=‘19283’
LastAction=‘add’
NodeType= ‘video’ | ‘image’ | ‘movie’
SortOrder=‘1’
Description=‘Tom Daley tells CNN‘s Phil Black that the London Olympics.’
IconURL=‘http://i2.cdn.turner.com/cnn/video/sports/2009/07/28/black.to

m.daley.intv.cnn.60x45.jpg|width=60|height=45’

FileLocation=‘http://cnn-0.vo.llnwd.net/c2/cnn/big/sports/

2009/07/28/black.tom.daley.intv.cnn 576x324 dl.flv’

Controlled=‘both | site | rating | none’
Scale=‘TV | MPAA’
Rating=‘PG-13’
Value=‘150’
SiteTitleID=‘19283767’
SiteAssetID=‘32084’
AppId=‘ivn’

/>

The metadata contained within the XML attributes of the above node tag provides a Title and Description of the piece of content. As discussed further below, such descriptive information can be presented via the user interface of a playback device as a user navigates through the ICG presented to the user by the playback device. The metadata also includes information concerning the LastAction (i.e., whether the metadata recorded in the database concerning the piece of content was last added, updated, or deleted). The LastAction attribute can be used when sending update information to an individual playback device. Instead of sending the metadata for the playback device's entire ICG, the metacenter can simply send information concerning added metadata, updated metadata or content that is no longer accessible via a feed. The updating of a playback device's individual ICG is discussed further below. The metadata collected with respect to a piece of content can also include URLs for an icon associated with the content and for the content itself. The metadata can also include information concerning a rating that has been assigned to the content. As is discussed further below, the rating can be used to filter the content that is displayed on an individual content guide via parental controls and/or ratings filters.

Organizing Content Metadata within the Content Metadata Database

Content metadata can be organized as part of a navigation hierarchy, where the content metadata is the lowest level in the navigational hierarchy (i.e., each piece of content metadata terminates a branch of the navigation hierarchy tree). Navigational nodes can be defined within the hierarchy defining categories including but not limited to genre, site and feed. These nodes are typically defined by an administrator and are not collected via metadata adapters. Indeed, these nodes typically define the feeds from which content metadata is collected using the metadata adapters. Metadata concerning each category defined by a navigational node can also be stored in a navigational node. The XML attributes of the following node tag provide an example of the metadata that can be stored with respect to a navigational node describing a site such as the CNN website:

<node

ParentID=‘8548’
ID=‘8549’
LastAction=‘add’
NodeType=‘nav’
SortOrder=‘1’
InventoryID=‘295’
Description=‘CNN’
IconURL=‘nav_cnn.png’
Name=‘CNN’
Controlled=‘site’
Scale=‘MPAA’
Rating=‘PG-13’/
Value=‘200’/
AppId=‘ivn’

/>

As with the node tag describing the piece of content metadata, the location of the node within the navigational hierarchy is defined via the ParentID attribute. Both the content metadata and the site metadata include rating information. As is discussed above, the rating information can be utilized when performing content filtering based upon rating.

Although a specific set of metadata for each piece of content and for each navigation node in the navigation hierarchy are discussed above, any of a variety of metadata can be collected with respect to different pieces of content and different categories described in a content metadata database as is appropriate to a particular application in accordance with an embodiment of the invention.

### Defining Navigation Hierarchies

Playback devices in accordance with embodiments of the invention can request a navigation hierarchy or a navigation hierarchy update from a metacenter in order to use the navigation hierarchy to generate an ICG via the playback device's user interface. The ICG presented by a first playback device can differ from the ICG presented by a second playback device for a variety of reasons including, but not limited to the capabilities of the device, filters that the user has requested be applied to the content (e.g., parental controls on specific feeds, or ratings filtering), subscription and/or premium content to which a specific user has access, and/or custom feeds defined by a specific user. The navigational hierarchy provided to the playback device by the metacenter defines the ICG presented by the playback device. In order to provide navigation hierarchies customized for specific devices, the content metadata database includes information defining the navigation hierarchies suitable for specific classes of playback device and for specific playback devices. The definition of navigation hierarchies and the presentation of an ICG on a playback device in accordance with embodiments of the invention are discussed further below.

### Defining the Scope of Different Playback Devices

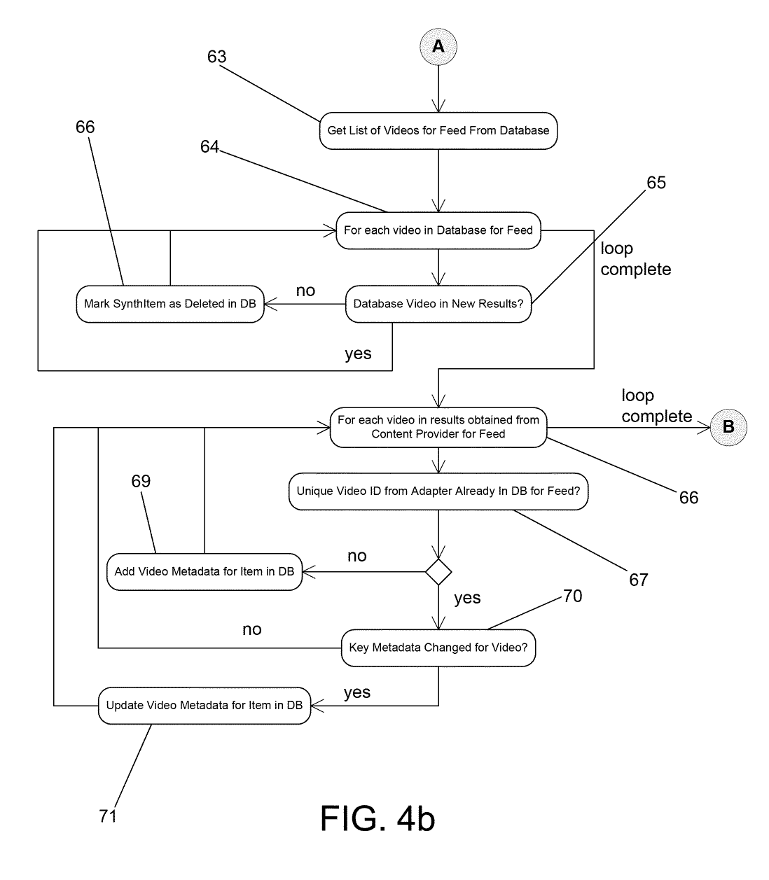

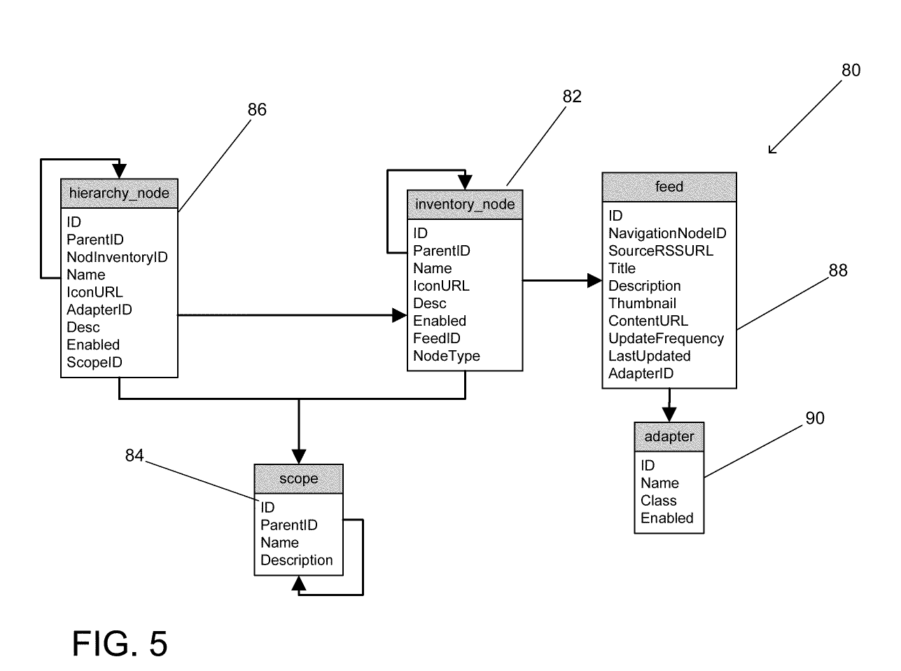

In many embodiments, the content metadata database organizes all of the content metadata collected by the metasynthesizer into a single navigation hierarchy and the content metadata database includes information concerning the portions of the navigation hierarchy that are accessible to different categories of playback devices. In this way, the database can define a specific navigation hierarchy for a class of playback device and/or for specific playback devices. Database tables within a content metadata database that defines navigation hierarchies for various playback devices in accordance with an embodiment of the invention are illustrated in FIG. 5. The tables 80 in the illustrated content metadata database include, but are not limited to, an inventory node table (82), a scope table (84), a hierarchy table (86), a feed table (88), and an adapter table (90).

The inventory node table (82) contains the catalog of navigable ICG nodes. In many embodiments, the types of navigable ICG nodes include: navigation nodes, which define a portion of the navigational hierarchy; content nodes, which include the metadata for a piece of content; and premium content nodes, which include the metadata for a piece of premium content. The treatment of subscription and/or premium content is discussed further below. The inventory node table (82) defines the nodes that can potentially appear in the ICG of a playback device. Stated another way, the inventory node table (82) defines a navigation hierarchy for the total universe of feeds and content of which the metacenter is aware and, as is discussed further below, this can also include custom feeds such as user content and/or custom feeds defined by a saved search query.

The hierarchical relationship of nodes in the inventory node table (82) provides an administrative template for how the nodes are expected to be used in a navigation hierarchy. For example, a news site in the inventory table can include the following children: the node describing the “Headline News” feed, the node describing the “World News” feed, and the node describing the “Staff Favorites” feed. These children should not be presented in an ICG below sites other than the news site. As is discussed further below, the inventory node table (82) also can be utilized to enable the viewing of custom feeds including but not limited to a user's personal content (e.g., photos, music, videos) and/or content identified by executing a saved search query.

The navigation hierarchy of nodes in the inventory node table (82) can be “scoped” for specific classes of devices and for specific individual devices using information in the scope table (84) and the hierarchy node table (86). “Scoping” the complete navigation hierarchy, means defining the nodes in the inventory node table that are included in the ICGs generated by specific device models and specific device instances. The term device model refers to a specific model of playback device manufactured by a manufacturer. A device instance is a specific playback device. There can be multiple device instances that are all the same model of device. The scope table (84) includes information defining the ICG information relevant to specific device models (typically OEM models) and to specific device instances. The hierarchy defined in the scope table (84) contains a parent-child relationship that is typically only two layers deep (i.e device model and device instance). The root scope has ID 0. Under this node are the device model scopes and the device instance scopes are under the device model scopes. In other embodiments, the scope table can define a hierarchy in other ways including a hierarchy that is more than two layers deep.

The hierarchy node table (86) defines the portion of the inventory node table within the scope of a specific device model or a specific device instance. The navigation hierarchy of the ICG for a device is typically defined by one or more administrators for the device model. In this way, different entities can define the content that is accessible by different classes of device. For example, manufacturers can define the content that is available based upon the playback capabilities of a specific device model and retailers can define content that is available for playback based upon relationships that the retailer has with content distributors. The navigation hierarchy of a specific device is primarily determined by the hierarchy defined in the hierarchy node table (84) for the specific device model scope. The navigation hierarchy is typically defined by the manufacturer of a specific playback device with consideration for the capabilities of the playback device. If a feed is known to utilize an encoding format not supported by the device model, it is not included in the model's navigation hierarchy. In many instances, a feed will include different types of content (e.g., VP6 and On2 FLV encoded files). Accordingly, the navigation hierarchy for a device model can be defined so that device-specific format is not included within the navigation hierarchy to ensure that all content displayed in the ICG presented to a user via a playback device is playable using the playback device. Further adaptations of the hierarchy can be made for specific playback device instances including but not limited to the addition of custom feeds for user content, saved search queries, and subscription and/or premium content. The additional adaptations are discussed further below.

The feed table (88) contains information used to acquire content metadata from various feeds of content sites. The inventory node table (82) includes a reference to the feed table for nodes that represent a site channel or category. An example of such a node is a node describing a “Headline News” feed within a news site. The node describing the “Headline News” feed is listed in the inventory node table (82), which includes a reference to the news site, and also a reference to the “Headline News” feed in the feed table (88). Each feed has a reference to its adapter in the adapter table.

The adapter table (90) provides a means to group feeds based on the common source of those feeds. An adapter entry also expresses a common source format. It holds a reference to the file that contains the metadata adapter that obtains a set of content metadata by processing the feed under the control of the metasynthesizer. The adapter table (90) also includes scheduling information for the metadata adapter, which is used on behalf of all feeds, which refer to a metadata adapter.

Although specific database structures are identified above for defining the navigation hierarchies of specific classes of playback device and for individual playback devices, alternative structures that define navigation hierarchies for playback devices appropriate to specific applications can be utilized in accordance with embodiments of the invention.

### Parental/Ratings Filtering

The navigation hierarchies defined in the content metadata database can be further limited based upon factors including but not limited to parental controls, and/or ratings restrictions. In a number of embodiments, parental controls can be defined for a specific playback device (i.e., device instance). A scope can be defined within the content metadata database for the playback device that specifies parental controls and/or ratings restrictions that are applied to the navigation hierarchy defined for the device model. In this way, the navigation hierarchy defined for the device model is filtered to remove nodes that are subject to the parental controls and/or ratings restrictions prior to the metacenter returning the filtered navigation hierarchy or a filtered navigation hierarchy update to the playback device. In this way, the navigation hierarchy received by the playback device enables the display of an ICG where the categories, and content displayed within the ICG conform with the parental controls and ratings restrictions defined by the user. In other embodiments, the playback device applies parental control and/or content ratings filters to the navigation hierarchy information received from the metacenter as part of the process of generating an ICG for display.

### Custom Feeds

The overall navigation hierarchy defined in the content metadata database can include custom feeds that are only accessible by individual users and/or groups of users. Access to the custom feeds is restricted by only including the nodes in the navigation hierarchy associated within the custom feed within the scope of the devices that have been granted access to the custom feeds. Examples of custom feeds include content feeds established by a specific user such as a user's photographs. A custom feed can also include a saved search query.

When the metacenter receives a request from a playback device for an update to its navigation hierarchy and the navigation hierarchy includes a saved search query custom feed, the metacenter can execute the search query and return the content returned in response to the search query as part of the navigation hierarchy update provided to the playback device. Alternatively, the metacenter can periodically perform the search and include the results of the query in the navigation hierarchy that is used as the basis for responding to the update request from the playback device. The search query can be a query of the content metadata within the content metadata database and/or can be a query of archive sites such as the YouTube service provided by Google, Inc. of Mountain View, Calif.

External search capability is typically provided with respect to archive sites that contain a large amount of content and provide an API defining how to search for content by site-defined criteria. In many embodiments, content metadata adapters include a user interface implementation independent template defining information that can be collected from a user to define the search criteria appropriate for the site. In several embodiments, the template is optimized to enable entry of the search criteria using a user input device such as a remote controller or a game controller. Additional functionality associated with interacting with specific content sites can be incorporated into content metadata adapters according to the requirements of specific applications in accordance with embodiments of the invention.

Subscription and/or Premium Content

The ability of a metacenter to provide a navigation hierarchy for a specific device provides considerable flexibility with respect to providing the playback device with access to premium and/or subscription content. In many embodiments, the metasynthesizer obtains metadata concerning content that is available via specific subscription and/or premium sites that are accessible via the playback device. The content metadata can be stored within the content metadata database in a similar manner to that used to store content from unrestricted sites. Referring back to the description of the database structure shown in FIG. 5 above, metadata content for subscription and/or premium content can be stored in a premium content node that is referenced in the inventory node table (82). The navigation hierarchies associated with subscription and/or premium content do not, however, fall within the scope (i.e., form part of the default navigation hierarchy) for device models. Instead, the subscription and/or premium content is within the scope of individual playback devices. Therefore, the registration of a specific playback device with a subscription and/or premium content service results in the expansion of the scope of the navigation hierarchy for the specific device instance corresponding to the playback device to include the navigation nodes and the content metadata associated with the subscription and/or premium content service.

When a playback device requests subscription and/or premium content listed within the IGC of the playback device, the request is not made directly to the subscription and/or premium content server. Instead, the request is made to the metacenter and the metacenter requests a URL that can be utilized to access the requested content from the subscription and/or premium content service.

A process for collecting metadata for subscription and/or premium content services and coordinating the playback of the subscription and/or premium content on a playback device in accordance with an embodiment of the invention is illustrated in FIG. 5a. The process involves the metasynthesizer collecting (102) metadata for the content from the subscription and/or premium content site, which also can be referred to as a restricted site. The metadata for the premium content is pulled to individual playback devices (104), which are registered with the subscription and/or premium content site and are authorized to access content from the site. As part of this process, URLs are generated for the subscription and/or premium content that point back to the metacenter. The premium and/or subscription content can then be selected (106) via the playback device's user interface, and a request (108) for the content made to the metacenter. The service that receives the request can parse the URL to determine which piece of content is requested and can also identify the playback device requesting the content. The metacenter can then request (110) a URL that can be utilized by the identified playback device to play back the content from the subscription and/or premium content service (e.g., a short TTL, token-encoded URL to the content). Before responding, the subscription and/or premium content service determines whether the playback device is entitled to access the requested content. In the event that the playback device is entitled to access the requested content, a URL enabling access to the requested content is provided (112) to the metacenter by the subscription and/or premium content service, and the URL is returned to the playback device as a redirect from the original request. The playback device can then utilize the URL to request the content from the subscription and/or premium content service.

### Playback Devices

Playback devices in accordance with embodiments of the invention typically take the form of televisions, set-top boxes, DVD/Blu-ray Disk players, mobile phone handsets or game consoles that combine Internet access capability with media playback hardware and/or software. The Internet connection provides access to the metacenter and content sites. In many embodiments, the playback devices utilize a navigation hierarchy obtained from the metacenter to construct a navigable IGC including content that the playback device is authorized to playback and is capable of playing back. The information contained in the user interface can be utilized to retrieve content via the Internet from the appropriate content site for playback using the media playback hardware and/or software of the playback device.

In a number of embodiments, a common client is utilized by playback devices to access the ICG, provide a user interface, and retrieve content for playback using the media playback hardware and/or software. Provision of a common client reduces the amount of development effort involved in enabling a playback device to access the ICG and content listed in the ICG. Manufacturers typically desire that the user interfaces of their products have a different look and feel to the products of other manufacturers. In several embodiments, the common client includes the ability to create a customized user interface. In many embodiments, the common client includes a native implementation of a Flash player and a user interface can be provided using SWF and/or FLV files. In other embodiments, any of a variety of techniques can be utilized to enable the creation of customized user interfaces in accordance with embodiments of the invention.

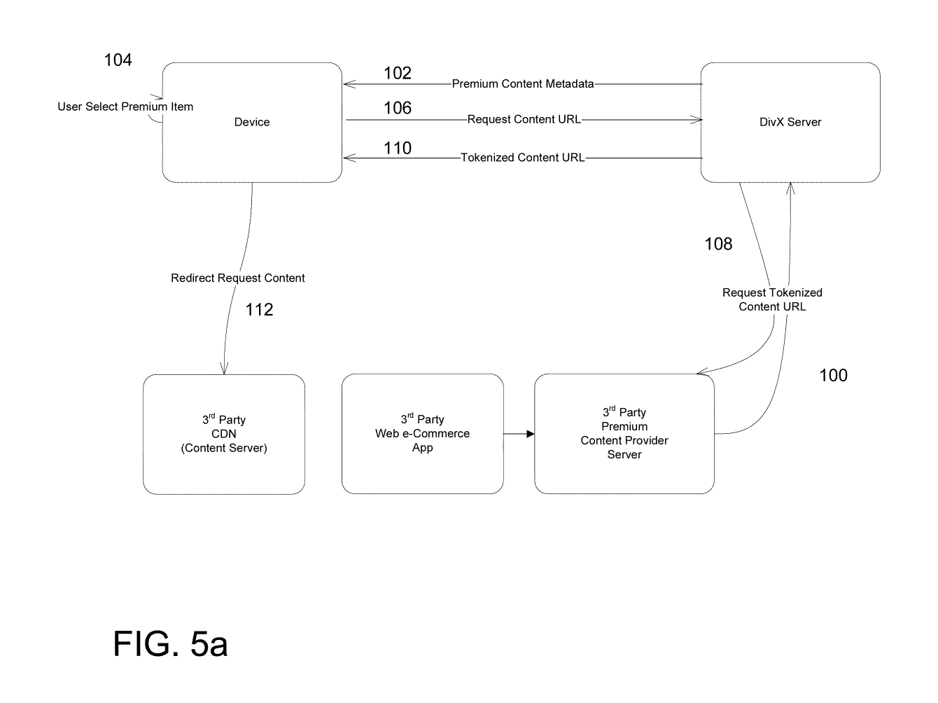

A playback device including a common client configured to display a custom user interface based upon information retrieved from an ICG in accordance with an embodiment of the invention is illustrated in FIG. 6. The playback device 12 includes hardware 150, an operating system 152, which can be an operating system such as a Linux derivative, and associated hardware drivers 154. The hardware, operating system, and drivers provide Internet connectivity and media playback capabilities. The playback device includes the capability to execute an application referred to as a common client application 156. The application is referred to as a common client application, because it is abstracted from the hardware implementation using a porting interface 58. The remainder of the application is largely implementation independent.

The common client include several components including a device application 160, which handles communication with a metacenter to obtain information from the content metadata database, and a Flash player 162, which provides a natively compiled virtual machine that is capable of running Flash Movies. Examples of suitable Flash players include MachBlue from Bluestreak Technology, Inc. of Montreal, Canada and Stagecraft (Flash Lite) from Adobe Systems Incorporated of San Jose, Calif. The user interface is typically implemented using Action Script that executes on the Flash virtual machine and, as a result, is completely customizable using common Flash authoring tools.

The user interface 164 requests information from the ICG via the device application 12. In a number of embodiments, the user interface communicates with the device application 160 via XML sockets. When communication is via XML sockets, the user interface and the device application 160 are asynchronous. In many instances, other techniques can be used to pass information between the two applications. The device application 12 returns the information retrieved from the metacenter, which can include a navigation hierarchy including URLs that is used to construct an ICG user interface including hierarchical paths that a user can traverse to select content for playback. The playback of the selected content is achieved using the media playback hardware and/or software of the underlying device. In many embodiments, the playback device pulls navigation hierarchy information from the metacenter to construct an ICG. The playback device can pull an entire navigation hierarchy every time a user request access to the ICG. Alternatively, the playback device can maintain a local ICG and pull updates to the navigation hierarchy from the metacenter periodically. Communication between the user interface and the hardware is typically through the embedded Flash player 162 and is synchronous.

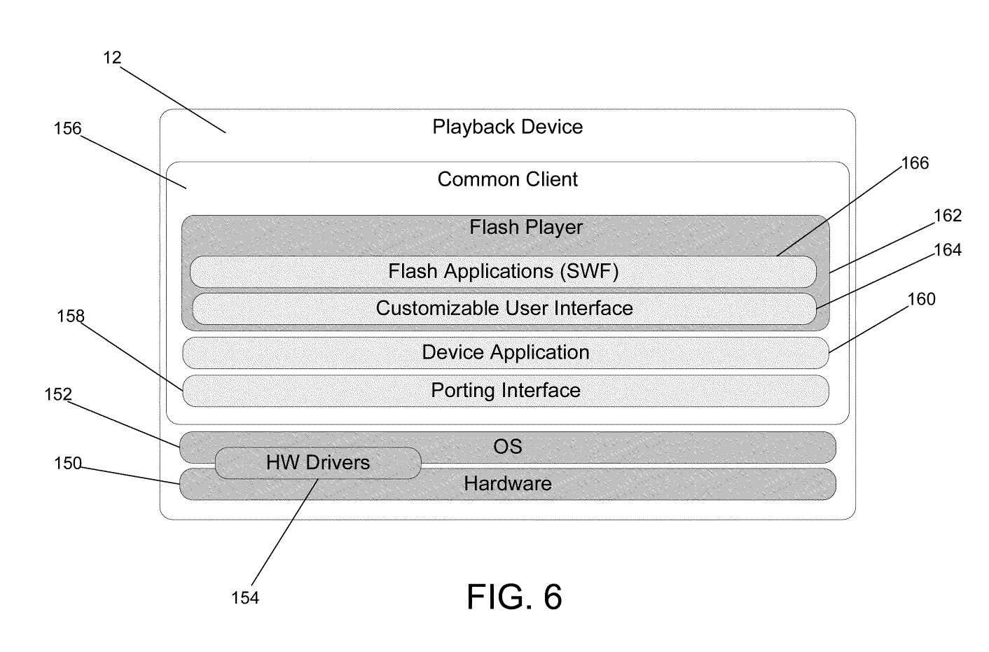

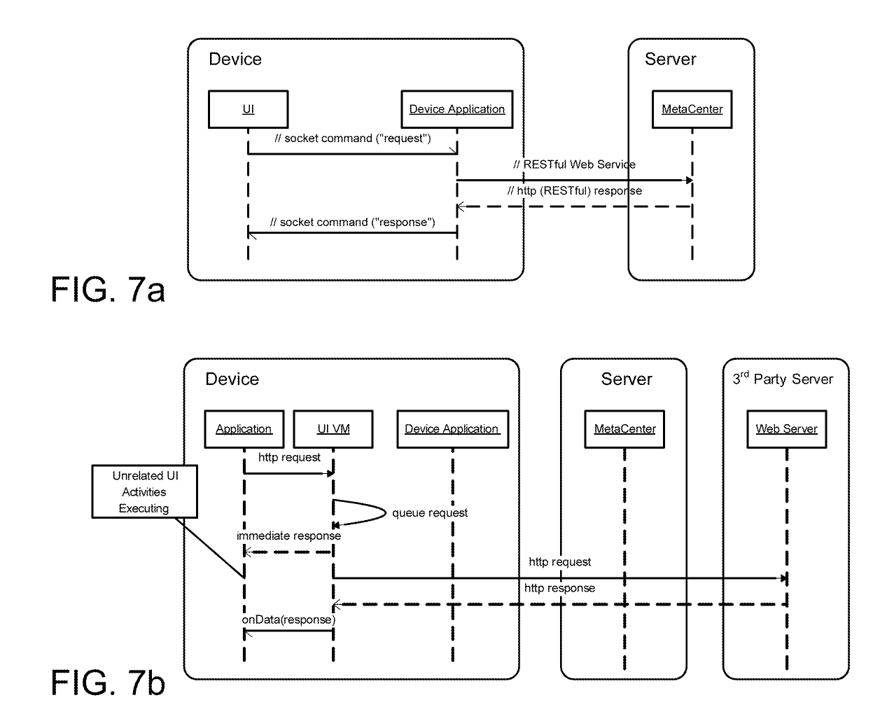

A process utilized by a playback device to request information from a metacenter in accordance with an embodiment of the invention is illustrated in FIG. 7a. In the illustrated embodiment, communication between the device application process on the playback device and the metacenter occurs as synchronous RESTful web services. However, any of a variety of synchronous and/or asynchronous communication techniques appropriate to specific applications can be utilized in accordance with embodiments of the invention. A user interface can also request static resources directly. A process by which a playback device can directly request information in accordance with an embodiment of the invention is illustrated in FIG. 7b. For example, graphic images such as logos and thumbnails can be loaded directly by the playback device. Also, the playback device can directly access some types of configuration information. Although the illustrated embodiment loads a resource from a 3^{rd} party server, the same type of request can be issued to the server hosting the metacenter. The extent to which a playback device requests resources directly is typically a function of the requirements of a specific application.

Although the generation of an ICG using navigation hierarchy information retrieved from a remote content metadata database is discussed above with reference to a common client implemented across multiple devices, navigation hierarchy information can be utilized by any of a variety of different playback devices utilizing different client applications in accordance with embodiments of the invention.

Although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed:

1. A system for generating Internet content guides appropriate to specific playback devices, comprising:
a metacenter configured to retrieve content metadata from feeds on a plurality of remote servers describing content accessible via the remote servers and to use the content metadata retrieved from the feeds to update a content metadata database; and
a plurality of playback devices configured to communicate with the metacenter and access content via the Internet;
wherein the content metadata database defines a plurality of navigation hierarchies for different playback devices, where each navigation hierarchy includes category information and content information;
wherein each playback device is configured to obtain a navigation hierarchy appropriate to the playback device from the metacenter, where the navigation hierarchy obtained by the playback device only includes category and content information that the playback device is authorized to access and is capable of playing back; and
wherein the playback devices are configured to generate an Internet content guide using the navigation hierarchy obtained from the metacenter.

2. The system of claim 1, wherein the a metacenter is configured to retrieve content metadata from a plurality of remote servers describing content accessible via feeds on the remote servers using metadata adapters configured to retrieve specific content metadata from a specific feed format.

3. The system of claim 2, wherein the metacenter further comprises a metasynthesizer that is configured to schedule the retrieval of content metadata from the plurality of remote servers in accordance with a predetermined schedule.

4. The system of claim 1, wherein content metadata retrieved from a feed by the metacenter with respect to a specific piece of content accessible via a remote server associated with the feed includes a unique identifier.

5. The system of claim 4, wherein the metacenter is configured to compare the unique identifiers of the content metadata retrieved from a specific feed to the unique identifiers of content metadata associated with the feed in the content metadata database, and associate content metadata with the feed, when the unique identifier of the content metadata does not match the unique identifier of any of the content metadata associated with the feed in the content metadata database.

6. The system of claim 5, wherein the metacenter is configured to mark content metadata within the content database as deleted when the unique identifier of content metadata associated with the feed in the content metadata database does not match any of the unique identifiers of the content metadata retrieved for the feed.

7. The system of claim 5, wherein the metacenter is configured to update the content metadata stored in the metadata database to reflect differences with the retrieved content metadata, when the unique identifier of the retrieved content metadata corresponds to the unique identifier of content metadata for a piece of content associated with the feed.

8. The system of claim 4, wherein the unique identifier for content metadata retrieved by the metadata adapter is the same every time the content metadata for the specific piece of content is retrieved from the feed.

9. The system of claim 1, wherein the content metadata database defines a complete navigation hierarchy comprising all categories and all content metadata within the content metadata database.

10. The system of claim 9, wherein the content metadata database defines scopes within the complete navigation hierarchy, where each scope limits the categories and content metadata to form a custom navigation hierarchy.

11. The system of claim 10, wherein scopes are defined for different classes of playback device.

12. The system of claim 11, wherein the scope is defined by an administrator based upon the content the class of playback devices is capable of playing back.

13. The system of claim 10, wherein scopes are defined for individual playback devices.

14. The system of claim 13, wherein the scope includes content from custom feeds.

15. The system of claim 14, wherein the custom feed is a content feed specified by a user.

16. The system of claim 14, wherein the custom feed is content metadata identified in response to the execution of a saved search query.

17. The system of claim 13 wherein the scope includes content metadata retrieved from at least one restricted site.

18. The system of claim 17, wherein:
the content metadata for content that is accessible via a restricted site includes information that directs the playback device to request access to the content from the metacenter; and
the metacenter is configured to obtain information from the restricted site enabling the playback device to access content on the restricted site in response to a request from the playback device to access the content.

19. The system of claim 10, wherein the scope includes user defined filters and the metacenter is configured to filter the navigation hierarchy based upon the filters prior to providing a custom navigation hierarchy to a playback device.

20. The system of claim 19, wherein the filter is a parental control filter that filters at least one category and associated content from the navigation hierarchy.

21. The system of claim 19, wherein the filter is a content rating filter that filters category and content metadata based upon assigned content ratings.

22. The system of claim 19, wherein the filter is a playback capability filter that filters content metadata based upon the playback capabilities of a playback device.

23. The system of claim 1, wherein each playback device utilizes a common client to obtain a navigation hierarchy from the metacenter.

24. The system of claim 1, wherein the playback device is configured to request a navigation hierarchy from the metacenter.

25. The system of claim 1, wherein the playback device is configured to request a navigation hierarchy update from the metacenter.

26. The system of claim 1, wherein the metacenter is configured to search content accessible via an archive site using a search metadata adapter for the site.

27. The system of claim 26, wherein the metacenter is configured to search an archive site in response to receipt of a search query from a playback device.

28. The system of claim 26, wherein the metacenter is configured to search an archive site using a saved search query in response to a predetermined event.
